(19) United States
(12) Patent Application Publication
(10) Pub. No.: US 2026/0051325 A1
(43) Pub. Date: Feb. 19, 2026

(54) MACHINE AND PROCESS FOR INTERPRETING SPEECH INTENTION FROM BRAIN ACTIVITY

(71) Applicant: The Board of Regents of The University of Texas System, Austin, TX (US)

(72) Inventors: Nitin Tandon, Houston, TX (US); Tessy M. Thomas, Houston, TX (US); John Seymour, Houston, TX (US); Aditya Singh, Houston, TX (US)

(21) Appl. No.: 19/298,712

(22) Filed: Aug. 13, 2025

Related U.S. Application Data
(60) Provisional application No. 63/682,670, filed on Aug. 13, 2024.

(51) Int. Cl. G10L 15/24; G06F 3/01; G06N 3/096; G10L 15/06; G10L 15/16; G10L 15/18; G10L 15/187

(52) U.S. Cl. CPC G10L 15/24; G06F 3/015; G06N 3/096; G10L 15/063; G10L 15/16; G10L 15/1815; G10L 15/187

(57) ABSTRACT

A computer-implemented method for decoding speech, language and related semantic neural activity includes: collecting neural signals from an array of electrodes implanted in or on a brain; extracting features from the neural signals to detect distributed signatures of linguistic encoding using non-contiguous coverage of the electrode array; and decoding linguistic units, including phonemes and semantic embeddings from the extracted features. The decoding can utilize a custom neural language model for a limited or impaired brain adapted from a generalized neural language model trained on other human brains with intact speech, linguistic and cognitive regions.

### CROSS-REFERENCE TO RELATED APPLICATION(S)

This application claims the benefit of U.S. Provisional Application Ser. No. 63/682,670, filed on Aug. 13, 2024, which is hereby included by reference in its entirety.

### STATEMENT REGARDING FEDERALLY SPONSORED RESEARCH

This invention was made with government support under R01 DC014589, U01 NS098981, and U01 NS128921 awarded by the National Institutes of Health (NIH). The government has certain rights in the invention.

### BACKGROUND

More than one million people in the US alone have been rendered aphasic, which is a condition that affects a person's ability to communicate. Aphasia may be due to damage to language areas by stroke, traumatic brain injury, neoplasia, or degenerative diseases. Patients with non-fluent aphasia have selective difficulty with finding words and speaking fluently but can comprehend spoken language.

Recent advancements in brain-computer interface (BCI) research have demonstrated the potential to decode speech using neural activity. BCI have been shown to be able to effectively interpret a lock—d-in patient's brain recordings to produce speech, using a focus on forcing the patient to try to move the associated muscles to try to produce speech, using the activity in the speech cortex to guide decoding. The initial success with this special case has resulted in most research and advances in this field focusing on a small area of the brain (e.g., the motor cortex) for decoding neurological signals associated with producing phonemes.

### BRIEF SUMMARY

A machine and process for interpreting speech and language intention from brain activity is described. Advantageously, through the techniques described herein it is possible to interpret speech and language intention from aphasic patients and others with impaired language or speech function who do not have a normal, preserved language cortex either by direct injury or disconnection, deviating from current techniques that have narrowly focused on detection of signals from the motor cortex of the intact brain.

The described approach can utilize a penetrating or subdural array. One such instantiation is an array of stereoelectroencephalography (sEEG) electrodes that are inserted deep into the brain tissue, to capture neural signals. Even assuming and in some ways leveraging non-contiguous coverage, features are able to be collected and decoded into linguistic units using a customized neural language model. In certain embodiments, a generalized neural language model is developed from inputs of a training population with intact language-related brain regions, which is adapted via transfer learning techniques into the customized neural language model.

In some aspects, a computer-implemented method of interpreting speech, language and related cognitive intention from brain activity includes: collecting neural signals from a penetrating array of electrodes implanted in a brain; extracting features from the neural signals to detect distributed signatures of linguistic encoding despite non-contiguous coverage of the penetrating array; and decoding linguistic units, including phonemes and semantic embeddings from the extracted features.

In some aspects, a system for interpreting speech, language and related cognitive intention from brain activity includes: a processor; and memory storing instructions thereon that when executed by the processor direct the processor to perform a method including training a generalized neural language model on recorded data from a group of subjects with intact and extensive coverage of language regions of their brains; adapting the generalized neural language model into a custom neural language model for a particular brain, where the language region of the particular brain is not intact; and decoding linguistic units, including phonemes and semantic embeddings from limited or impaired neural recordings of a human having an aphasic or neurologically disordered brain with a non-intact language region using the custom neural language model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a system for decoding language related neural activity. Language here relates to all processes engaged in the perception, comprehension, conceptualization, assembly and production of spoken and written words and sentences

FIG. 1B shows linguistic units produced by a decoder can include phonemes and semantic embeddings.

FIG. 1C shows the set of linguistic units can be processed by a language processing engine to generate language outputs, such as speech.

FIG. 1D shows electrodes from a penetrating array are implanted within regions of the brain.

FIG. 1E shows a neural language model used by decoder, which is stored in a storage medium.

FIG. 1F shows the decoder including a temporal convolutional layer, a recurrent neural network, and a linear decoder.

FIG. 2A shows a generalized neural language model trained by a training population.

FIG. 2B shows raw neural signals from training subjects being filtered into neural signals used to train a neural language model.

FIG. 2C shows a generalized neural language model being adapted to a custom neural language model via transfer learning techniques.

FIG. 3A is a method of interpreting speech intention from brain activity.

FIG. 3B is a method where a custom neural language model is adapted from a generalized neural language model to allow decoding of linguistic units from humans not having intact language regions of their brain.

FIG. 3C is a method for preparing a human with a mal-region in their brain for a customized neural language model.

FIG. 4 shows a system for decoding language related neural activity for some specific embodiments.

FIG. 5 illustrates a schematic diagram illustrating components of a computing device that may be used in certain implementations described herein.

FIG. 6 is a schematic representation of a sequence-to-sequence model utilized in the case study.

FIG. 7 shows charts related to applying transfer learning to neural models in the case study.

FIG. 8 presents a series of charts related to results of adapting a custom neural language model from a generalized neural language model.

### DETAILED DESCRIPTION

A machine and process for interpreting speech intention from brain activity is described. In certain embodiments, a neural language model is developed with extensive coverage translating brain activity for linguistic processing. In some embodiments, the neural language model may be task-agnostic and able be used for encoding/decoding when speaking, reading, writing and performing other internal and external language and related cognitive tasks. A generalized neural language model is able to be adapted, through transfer learning techniques, to specialized neural language models, including those developed for aphasics with one or more regions of their brain not being intact.

In certain embodiments, a penetrating or subdural array of electrodes can be implanted to collect the neural signals being encoded/decoded. As used herein, electrodes may refer to conductive contacts in or on the parenchyma, which sense brain activity. For example, sEEG or high-density sEEG (HD sEEG) electrodes can be inserted deep into the brain tissue, to capture neural signals of high-fidelity. In some embodiments, sEEG electrodes may have a ring contact design. In certain embodiments, the sEEG electrodes may incorporate microelectrodes, such as those with a diameter of around 40 μm. In some instances, use of a combination of depth electrodes and surface electrodes can be beneficial, such as when subdural contacts are placed with minimal skull removal for the safety of a patient.

The sEEG electrodes may be sparse, spatially distributed electrodes able to be implanted in a minimally evasive fashion. HD-sEEG electrodes have a similar size and shape but typically with more contacts having a smaller diameter. Conventionally, sEEG electrodes have been used to pinpoint the source of seizures in patients with drug-resistant epilepsy. The sEEG electrodes enable access to distributed brain regions, including those proximate to the articulatory cortex. Even when regions of the motor cortex are damaged, the brain is generating patterned signals during attempts at language production, which are captured as sEEG recordings.

The sEEG recordings of populations of people having implanted sEEG electrodes are used to train an artificial intelligence (AI) engine for speech, effectively creating a generalized model using the neural recordings able to be used by a speech, language and related cognitive decoder. The population used to train the AI includes those with intact speech and language cortex structures and can also include those with damaged ones. The population can have implanted iEEG electrodes as a result of having some other neural disorder or can have been subjects of a neural augmentation procedure. Drug resistant epilepsy patients, who naturally have sEEG electrodes implanted are a candidate population for AI training from among the undamaged language center population. In embodiments, a damaged region can be defined, and decoding signals-to-speech can be biased for regions outside this damaged region. Transferred learning techniques can be used to refine a generalized language model based on a large population to a specialized language model tailored for a specific individual.

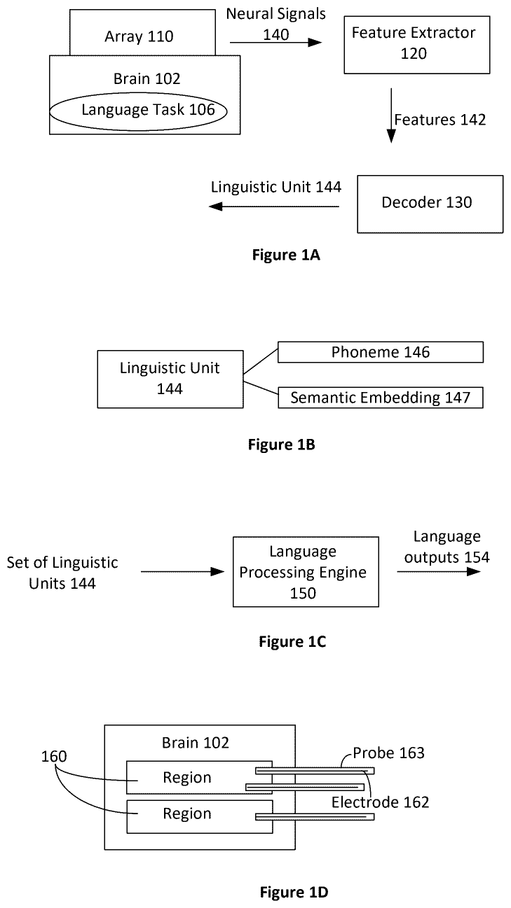

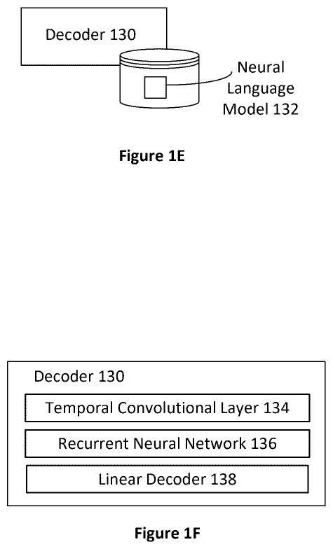

FIG. 1A shows a system for decoding language related neural activity. Neural signals 140 are collected from an array 110 of electrodes implanted in or on a brain 102. The array 110 of electrodes can be in the form of one or more multiple electrode arrays. In some cases, the neural signals 140 can be stored for later processing. Features 142 from the neural signals 140 are extracted by a feature extractor 120 during a language task 106. The features 142 are decoded, via decoder 130, into sets of linguistic units 144, which can include phonemes 146, semantic embeddings 147, word predictions, sentence predictions, and other related cognitive operations such as internal speech, as shown in FIG. 1B.

The language (or related speech or cognitive) task 106 can be naturalistic (i.e., occurring in everyday settings and real-life communicative interactions) or constrained (i.e., structured and controlled tasks designed to assess or target specific linguistic skills). Naturalistic language/speech/cognitive signals are able to be captured from those being monitored after a sEEG array is installed, which currently occurs for some patients suffering from drug resistant epilepsy. In some embodiments, the task 106 is an experimentally or artificially constrained language, speech, or cognitive task.

The features 142 can refer to brainwave features, such as synchronized theta and gamma oscillations, which can reflect the brain's internal processing of syllables, phonemes, and other speech, language, or cognitive components. In certain embodiments, gamma-based oscillations, such as those described in more detail herein, can be especially useful for discerning meaning from language embedded signals.

Phonemes 146 refer to perceptually distinct units of sound in a specified language. English includes forty-four distinct phonemes 146. Phoneme decoding in context of BCI refers to capturing a neural fingerprint or signature of speech sounds as they are being mentally formulated or attempted and then to translate these neural signals 140 into a recognizable form.

Semantic embeddings 147 allow a BCI to discern the underlying the meaning, context and derivations of a linguistic unit. Semantic embeddings 147 can be numerical representations of words for meaning. Semantic embeddings assign a numerical vector to each word, where words with similar meanings have vectors that are closer to each other in a multi-dimensional space. Semantic embeddings can be static or contextual intrinsic properties of meaning expressed in individual lexical elements or transformed by the context of proximate words.

FIG. 1C shows the set of linguistic units 144 can be processed by a language processing engine 150 to generate language outputs 154, such as speech. In certain implementations, discrete latent codes can be utilized to capture linguistic and paralinguistic aspects of speech production or perception, thereby acting as a bridge between neural signals 140 and generated speech output, which is one type of language output 154.

The feature extractor 120 enables the creation of a lower dimension representation, referred to as a latent space, which can capture underlying features or patterns in the neural signals 140. While the latent space is commonly formed at a lower dimensional space, there are cases where the dimensionality of the embedding space that the feature extractor 120 projects to is larger than the dimensionality of the data itself (i.e., projection transformation) The latent representation can be considered to be a compressed and meaningful encoding of linguistic data. Instead of relying on a continuous latent space, discrete latent codes divide a representation into a finite set of symbols or codes. Each code can represent a specific aspect of speech such as phonetic or, when included, articulatory features (capturing the basic sounds or movements involved in speech production), speaker-specific details (allowing synthesized speech to possess characteristics of a user's voice), and linguistic content (representing the meaning of words being conveyed). Accordingly, the decoder 130 can map brain activity into discrete latent codes, where a sequence of decoded discrete codes is used by the language processing engine 150 to model desired speech output. A speech synthesizer can translate the discrete codes into a speech waveform or text.

In some embodiments, the decoder 130 is able to generate speech, linguistic or semantic units 144 from sparse neural recordings. Sparse neural recordings means that at a given moment only a relatively small subset of neurons within a population is actively firing or responding strongly to a stimulus or condition. In embodiments, the decoder 130 is configured to determine linguistic units even when a linguistic region of the brain 102 is damaged, referred to herein as a mal-region. A mal-region can be a cause of aphasia. Language outputs 154 can be generated to assist a patient suffering from aphasia in some embodiments.

In certain instances, neural signals 140 forming the features can be spatially distributed over relatively broad area of the brain 102. The decoder 130 can utilize a set of distributed signatures of linguistic encoding to accurately generate the linguistic units 144. This can occur even when there is non-contiguous coverage as is common when the brain 102 has lesions or damaged areas of brain tissue.

FIG. 1D shows electrodes 162 from the array 110 are implanted within regions 160 of the brain 102. Electrodes 162 are contained within probes 163, which are devices used to house and deliver sets of electrodes 162 to specific locations of the brain 102. In some embodiments, the array 110 of electrodes 162 is a penetrating array. In certain embodiments, the electrodes 162 are implanted across a sparsely distributed cortical and/or subcortical regions 160 implicated in language generation or production.

In a penetrating array, electrodes 162 penetrate the neural tissue to record neural signals 140 from individual neurons or small groups of neurons. A penetrating array allows for closer proximity to neurons than non-invasive subdural grids resulting in stronger clearer neural signals 140 in some conditions and especially signals from deeper brain structures. Within a penetrating array, each electrode 162 acts as a tiny sensor, detecting the electrical activity of neurons in close proximity to its contact surface. Accordingly, electrodes 162 penetrate neural tissue and are able to record electrical signals, such as action potentials (single spikes), muti-unit activity (synchronous spikes), high gamma activity, and local field potentials (LFPs) with high spatial and temporal resolution. A penetrating array allows for detailed recording of neural firing patterns and network activity. In certain embodiments, directionally sensitive electrode arrays can be used, which advantageously offer a great diversity of signal types

By way of a non-limiting example of a penetrating array, in one configuration each probe 163 can include multiple platinum iridium electrodes 162 that each comprise a length of 0.5 millimeters or 2.0 millimeters with a center-to-center spacing of 0.5 to 4.43 millimeters. An illustrative BCI system can record at 2 kilohertz; filter out recordings that comprise muscle artifacts or acoustic contamination; identify signals with a significant change in broadband gamma activity within 500 to 250 milliseconds prior to an onset of an articulation; and classify an accuracy of a decoded signal. The accuracy may be based upon a linear discriminant analysis with a 5-fold cross-validation.

In some embodiments, a minimally invasive sEEG procedure may be elected. The sEEG procedure may use stereotactic guidance to place electrodes 162 precisely, targeting specific regions of the brain 102. Electrodes 162 can be placed using sEEG or HD-sEEG technology via minimally invasive probes 163 placed precisely throughout the brain 102 enables avoiding lesions and/or damaged areas of the brain (collectively referred to as mal-regions) while still enabling recording of a distributed cortical representation of brain activity across multiple sulcal and gyral sites in both dominant and non-dominant hemispheres that elucidates language neurobiology in neural targets.

A language production network in the human brain involves multiple regions distributed across large portions of the brain 102, such as the frontal and temporal cortices. A majority of aphasic patients do not have a normal, preserved language cortex, which leads to focused decoding based on “traditional” language regions unviable. Other regions of the brain 102, however, can provide the language encoding neural signals.

In some embodiments, the regions 160 of interest can be located in or around an articulatory cortical region in the brain. In some cases, neural signals can be collected from at least two of these regions 160. The regions 160 may include a precentral gyrus, a ventral sensorimotor cortex, a lateral temporal cortex, a ventral temporal cortex specifically but not exclusively the fusiform gyrus, an inferior parietal cortex, an inferior frontal gyrus (IFG), a middle frontal gyrus (MFG), a subcentral gyrus (SCG), a superior temporal gyrus (STG), a middle temporal gyrus (MTG), a lateral premotor cortex, a medial premotor cortex including the supplementary motor area, an inferior parietal cortex, an inferior frontal sulcus, a superior frontal sulcus, a superior temporal sulcus, an inferior temporal gyrus, and an occipitotemporal sulcus.

FIG. 1E shows a neural language model 132 used by decoder 130, which is stored in a storage medium. A neural language model 132 is a computational model, typically a neural network, that helps decode and interpret brain signals related to language to generate linguistic units 144. In some embodiments, the neural language model 132 can be task-agnostic and generalized for language activities of different modalities, such as reading, listening, and speaking. In some embodiments, the language model 132 can be used for decoding and encoding tasks.

FIG. 1F is an example implementation of decoder 130 in which decoder 130 includes a temporal convolutional layer 134, a recurrent neural network 136, and a linear decoder 138.

The temporal convolution layer 134 is a component of a neural network that can process brain signals, specifically applying a set of learned filters along the temporal (time) dimension of the input signals. The temporal convolution layer 134 filters spans across multiple recording electrodes and helps the decoder 130 identity patterns in brain signals over time that correspond to specific linguistic mental intentions within a lower-dimensional space (latent space). The temporal convolution layer 134 performs joint spatiotemporal filtering of the neural signals 140 to provide features that are temporally aligned and spatially informative.

To elaborate, neural signals 140 are inherently a type of time-series data, meaning the neural signals 140 unfold over time and exhibit temporal dependencies. The temporal convolution layer 134 applies a bank of N temporal filters that operate with a defined kernel length and stride to the multi-electrode neural signals 140. These signals are structured as a multivariate time-series, where each timepoint contains activity recorded from a set of electrodes. Each convolutional filter operates across all input channels simultaneously, learning to identify coordinated activity patterns over time. The output of this layer is a transformed representation in which each filter highlights a distinct spatiotemporal motif within the neural activity, enabling downstream decoding of linguistic or cognitive states.

The recurrent neural network (RNN)136 is a type of neural network particularly well-suited for decoding neural signals 140. Neural signals 140 are inherently sequential, meaning the order of data points over time matters, and RNN 136 excels at processing sequential data. The RNN 136, especially variants like Long Short-Term Memory (LSTM) and Gated Recurrent Units (GRUs), enhance the capability of standard RNNs by incorporating gating mechanisms that selectively retain or discard information across time. These architectures improve robustness to noise, facilitate learning from variable-length sequences, and enable the decoder to track long-range dependencies within the neural signal.

The linear decoder 138 is a type of decoder that relies on a linear relationship. Linear decoder 138 can assume a simple, direct relationship exists between neural activity and output. The linear decoder 138 can use a weighted sum of the neural signals 140, where the weights are learned during a calibration or training phase.

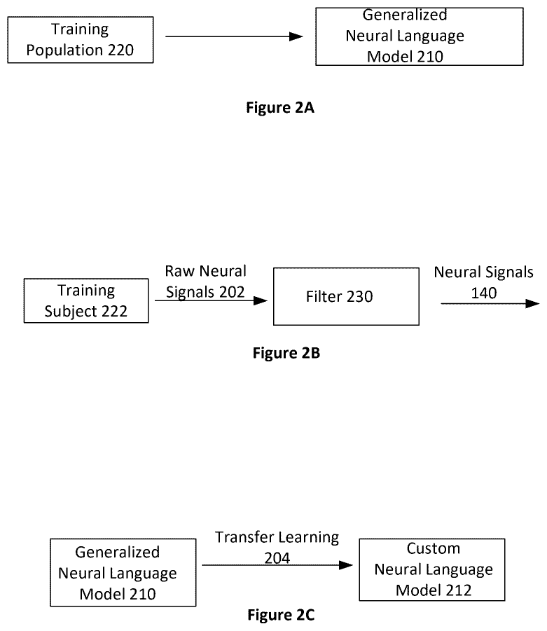

FIG. 2A shows a generalized neural language model 210 trained by a training population 220. The generalized neural language model 210 is a type of neural language model 132, which can be considered a foundational model that is trained on data across multiple subjects. Traditional BCI models are often trained on specific individuals or small groups, which limits their applicability to a wider population. A generalized neural language model 210 is one specifically developed to work effectively for individuals with different brain signals and characteristics, without necessarily requiring extensive individual training. Advantageously, as described in more detail below, through appropriate application of neural modeling including foundation models, transfer learning, and discrete latent representation, it is possible to develop generalizable systems trained on diverse populations.

Challenges in generalizing a language model include individual variability in that each person's brain generates unique neural signal, even though some similarities exist across a training population 220. Presently, no existing corpus discerning these similarities readily exists.

One resolution to this challenge, contemplated herein, relies on leveraging an existing population for which penetrating arrays have been implanted. Specifically, sEEG electrodes and subdural grid arrays are often installed in patients suffering from drug resistant epilepsy, as part of an epilepsy treatment process. These probes can generally be referred to as intracranial EEG or iEEG. This patient population are candidates for the training population 220. Brain activity input is a function of the recording technology and generally larger contacts, which may lack multi-unit activity, provide low noise high gamma, and LFPs. Smaller contact probes may provide multi-unit or potentially single unit activity. The training population is not limited to drug resistant epilepsy patients and effectively any population implanted with penetrating arrays, subdural arrays, or other sensors capable of detecting brain activity able to be correlated to neural signals from array 110.

In certain embodiments, as shown by FIG. 2B, raw neural signals 202 from training subjects of the training population 220 can be filtered by filter 230, where the filtered neural signals 140 are used to train the generalized neural language model 210. The filtering can exclude abnormalities due to individual derangements, which can be caused by biological sources or by non-biological sources, such as electrical noise. For example, abnormal neural activity attributable to epilepsy can be filtered out to ensure the neural signals 140 used to train the generalized neural language model 210 are not degraded by anomalous signals resulting from a unique patient condition. In this manner, when the group of subjects used for training a generalized neural language model have depth or sEEG electrodes or surface or subdural grid arrays implanted as a result of having epilepsy, the raw neural signals from the group of subjects used to generate training neural signals can be filtered before being used to train the generalized neural language model.

In some embodiments, specific attention to correlations of regions 160 of the brain and responsive neural signals 140 used for training can be incorporated into the training corpus and to the features 142 extracted from the neural signatures. For example, “typical” features 142 of the motor cortex mapped to linguistic units can be associated with related activity from other brain regions, for which features 142 are extracted. Since many aphasics have a mal-region (damaged) region in their brain typically responsible for handling linguistic tasks, a custom neural language model 212 can be developed from the generalized language model 210 using transfer learning 204 (see FIG. 2C) techniques such that the custom neural language model 212 is not reliant on signals from the mal-region. The above filtering of signals by brain region is just one example of potential adjustments for adapting a generalized neural language model 210 to a custom language model 212, as other transfer learning 204 techniques apply.

In some embodiments, a generalized neural language model 210 from a training population 220, which includes training subjects 222 without mal-regions, is adapted via transfer learning 204 to create custom neural language models 212 for a recipient with a mal-region. That is, the recipient is subject to incomplete neural coverage, which may result from structural brain damage. Specifically, the general language model 210 is pre-trained on data from a training population 220 with intact and extensive coverage of language-relevant regions. As part of adapting the custom neural language model from the generalized neural language model, a mapping is created between the shared latent representation space and a recipient subject's sEEG features. Fine-tuning, weight freezing, projection transformation and other performance optimization techniques can be used for this mapping. The resulting custom neural language model 212 can be tailored for the recipient's limited or impaired neural data. Accordingly, as reflected in FIG. 1C linguistic units 144 are decoded and language outputs 154 result, despite the recipient having a mal-region, which would impede an ability of a typical decoder from functioning.

As used herein, transfer learning 204 is a technique where a model trained on one or multiple sets of data is reused as the starting point for a model on an unseen dataset, which is often beneficial when labeled data is scarce or when training a model from scratch is computationally expensive. Transfer learning can be particularly needed for aphasics, which lack an ability to easily communicate and thus have a challenge training a model to interpret their neural signals during language (or other cognitive) tasks 106. Further still, training a customize neural language model tailored to aphasics with incomplete neural coverage, without leveraging transfer learning techniques is presently unviable.

Fine tuning involves taking a pre-trained neural network model (e.g., generalized neural language model 210) and further training it on a smaller, task-specific dataset. The dataset can include neural signals 140 subsets that exclude those from mal-regions. Fine tuning can involve techniques, such as weight freezing, projection transformation, low-rank adaptation, and the like.

Weight freezing is a technique where some neural network weights of a pre-tuned model (generalized language model 210) are kept fixed and not updated during a training process. By freezing early layers of the network (e.g., recurrent neural network 136), the model (e.g., custom neural language model 212) retains an ability to recognize broad patterns, while allowing later layers to learn task-specific features from the new BCI data, improving accuracy and efficiency. Weight freezing in fully connected layers can help to selectively influence decision-making based on specific input neurons, such as those located outside the mal-region.

Projection transformation involves transforming raw brain signal data (e.g., raw neural signals 202) into a more suitable representation often through embedding techniques. For example, brain signal data can be projected onto principal components, which represent the directions of maximum variance in the data. This can help to capture the most important information within the raw neural signals 202 while reducing noise and redundancy. Projection transformation can, for example, project brain activity at a particular layer onto two-dimensional cursor coordinates using a fixed projection matrix to control a cursor.

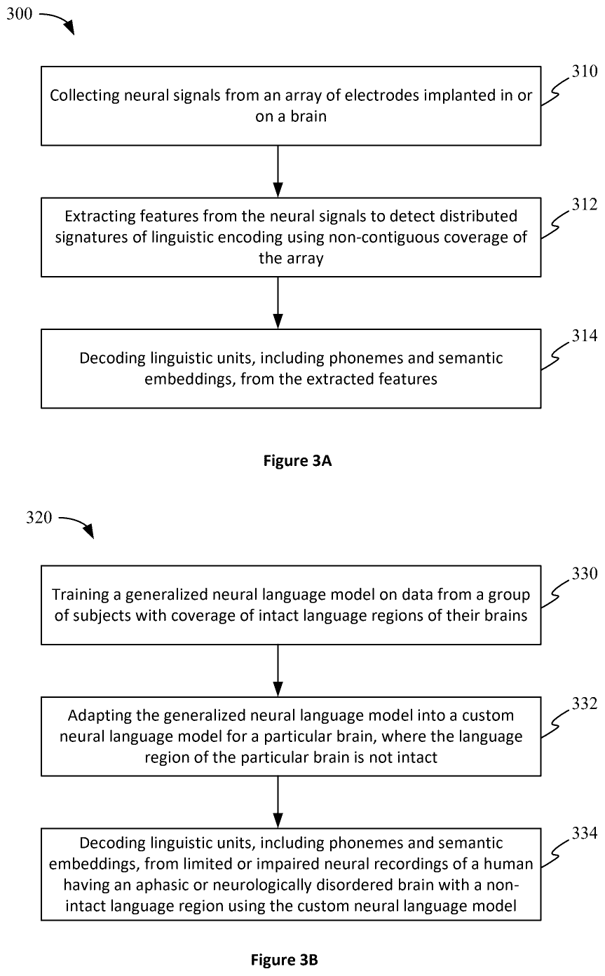

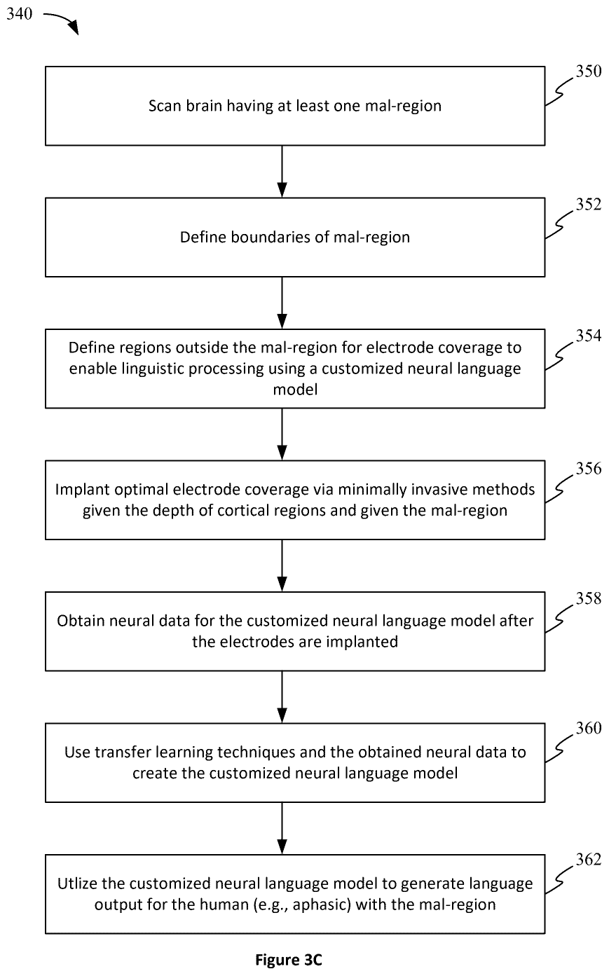

FIG. 3A is a method 300, which can be computer-implemented, of interpreting speech intention from brain activity. In operation 310, neural signals 140 are collected from an array 110 of electrodes 162 implanted in a brain 102. In operation 312, features are extracted from neural signals 140 to detect distributed signatures of linguistic encoding. These features 142 are extracted using non-contiguous coverage of the array 110 (e.g., from one or multiple electrode arrays). In some cases, feature 142 are extracted from intact portion of a brain, including by mapping a portion of the brain from which the neural signals from the array of electrodes are collected to delineate a region that is not intact (or having a non-intact language region); and limiting the collected neural signals from which the linguistic units are produced to signals from intact portions of the brain. In operation 314, linguistic units 144, including, but not limited to, phonemes 146 and semantic embeddings 147, are decoded from the extracted features 142. The decoding (314) can be carried out using a custom neural language model for the brain 102. The custom neural language model can be adapted from a generalized neural language model.

FIG. 3B is a method 320 where a custom neural language model is adapted from a generalized or generalizable neural language model to allow decoding of linguistic units from humans not having intact language or cognitive regions of their brain or from humans for which there is a disfunction of speech, language, or cognitive intention. In operation 330, a generalized or generalizable neural language model is trained on recorded data of language regions of brains from a group of subjects with intact and extensive coverage of language regions of their brains. The subjects have intact speech, language, and/or cognitive intention and function. The data can be collected from subjects having an implanted penetrating array from which neural signatures are collected. In some cases, the generalized or generalizable neural language model is task-agnostic applying to reading, listening, and speaking during language tasks. In some cases, the generalized or generalizable neural language model is a parameterized model for a standardized 3D brain space using surface-based node and cortical spread features in a latent space built from compressing neural data or neural data labeled with linguistic units. In some cases, the generalized or generalizable neural language model correlates features to regions of the brain generating neural signals from which the features were extracted. In certain embodiments, the regions of the brain being recorded from or remediated by the generalized or generalizable model include both the cortical and subcortical regions.

In operation 332, the generalized neural language model is adapted into a custom neural language model for a brain such as from which the neural signals from the penetrating or subdural array of electrodes are collected in method 300. Here, it is possible to develop a custom neural language model for a brain that is not intact or that there is dysfunction of speech, language, or cognitive intention. The custom neural language model is one fine tuned to the needs of a particular individual it is applied to. The adaptation can be carried out as described above with respect to FIGS. 2A-2C, including by creating a mapping between a shared latent representation space and the brain from which the neural signals from the penetrating array of electrodes are collected. In some cases, the adapting further comprises performing one or more of fine-tuning, weight freezing, and projection transformation during the creating of the mapping. In some cases, the mapping can be from a portion of the brain from which neural signals are collected to delineate the neural code of a region that is not intact in another person. In some cases, when adapting the generalized neural language model, the custom neural language model primarily utilizes features of the generalized neural language model related to regions of the brain outside the region that is not intact.

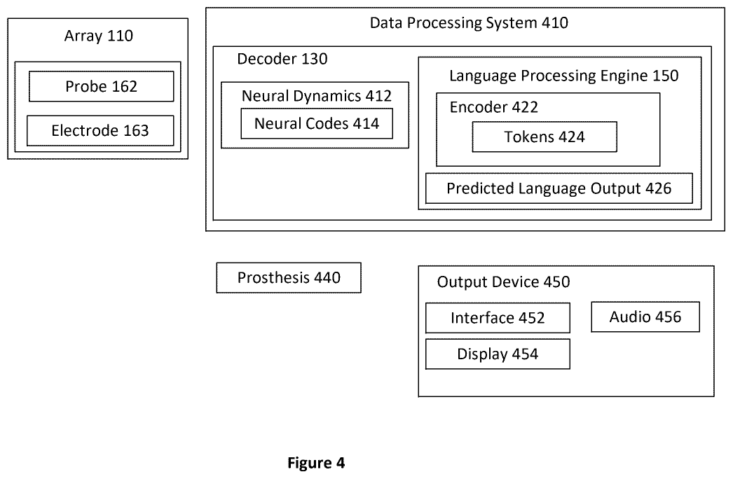

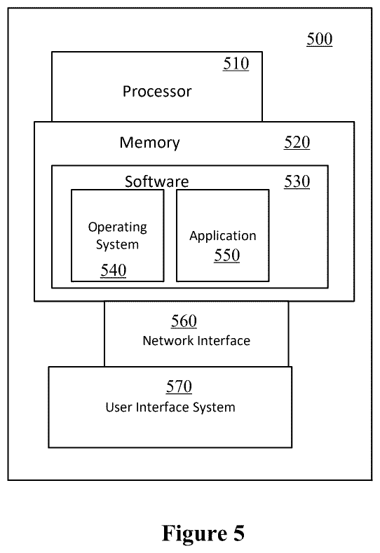

In operation 334, linguistic units, including phonemes and semantic embeddings, are decoded from brain waves of an aphasic human (or with a human with any neurological disorder) having the brain that is not intact using the custom neural language model. Methods 300 and 320 can be carried out by a system such as described with respect to FIG. 4 and/or FIG. 5.

FIG. 3C is a method 340 for preparing a human with a mal-region in their brain for a customized neural language model. In operation 350, a brain having at least one mal-region is scanned. In operation 352, boundaries of the mal-region are defined. In operation 354, regions outside the mal-region are defined for electrode coverage to enable linguistic processing using a customized neural language model. In operation 356, electrodes are implanted using an intracranial electroencephalography neural array (iEEG). Implantation can occur to provide optimal electrode coverage via minimally invasive methods given the depth of cortical regions and given the mal-region. Optimal coverage can include an electrode configuration with limited redundancy in brain activity recording, which is a function of the spatial extent of the activity of interest. In operation 358, neural data is obtained for the customized neural language model after the electrodes are implanted. In operation 360, transfer learning techniques and the obtained neural data is used to create the customized neural language model. In operation 362, the customized neural language model is used to generate language output for the human with the mal-region. This human can be aphasic due to the mal-region.

FIG. 4 shows a system for decoding language related neural activity for some specific embodiments. The decoder 130 can be part of a data processing system 410. The data processing system 410 also includes language processing engine 150, which includes encoder 420, which can utilize tokens 422 in some embodiments. A prosthesis 440 can be integrated in system 410, as can other output devices 450.

According to certain implementations, neural signals 140 from brain 102 may be passed through electrodes 162 of probes 163 to the data processing system 410. Decoder 130 may receive neural signals 140 from a brain 102 of an individual or group (e.g., for generalized model described with respect to FIGS. 2A and 2B). A group may be formed from a cohort of signals received from numerous individuals experiencing similar and/or different stimuli/testing, such as one or more language task 106. Linear classifiers in decoder 130 may be trained to decode distinct linguistic units 144, such as speech components. Speech components may include, without limitation, articulatory and/or phonemes. Decoding performance may be evaluated using nested 5-fold cross-validation. Decoder 130 can apply sequence-based decoding in a sequence to a sequence model processed through temporal convolutional layer 134, recurrent neural network 136 and linear decoder 138 (see e.g., FIG. 1F) to isolate identity (ID) of phonemes 146. Neural signals 140 may receive initial bandpass filtering of the raw electrode data, transforming the signals into broadband gamma activity (BGA) within the frequency range of 70 to 150 Hz while simultaneously eliminating line noise using zero-phase second-order BUTTERWORTH band-stop filters. Subsequent to this preprocessing step, a frequency domain bandpass HILBERT transform with paired sigmoid flanks and a half-width of 1.5 Hz may be applied. The resulting analytic amplitude may undergo further refinement through smoothing using a SAVITZKY-GOLAY finite impulse response method, specifically employing a third-order filter with a frame length of approximately 201 milliseconds.

A specially programmed sequential state-based model can be used by decoder 130 to exceed singular linear model performance in reconstructing phoneme sequences from continuous samples of neural signals. Applying the decoding process across multiple individual samples and trials/tests provided for developing a robust model (e.g., generalized neural language model 210) from a group (e.g., training population 220) that benefited from the global dynamics of the data for neural dynamics 412 for the group and allowed production of novel group training dataset that provides for transfer learning with neural data to predict neural intent at least by leveraging multi-site cortical data, models are initialized on a flexible set of neural codes 414.

A framework with decoder 130 and encoder 420 allows for sequence-based decoding that may utilize convolutional, long short-term memory, models that effectively capture, recognize, and decode latent temporal articulatory and acoustic information. Novel transfer learning to the group from individuals may use sequence-based model and adds a simple 1-dimensional convolutional layer on top of long short-term memory (LSTM) and affine layers. This allows pre-train group training dataset on an individual where a core LSTM layer and affine layer are frozen—meaning weights of those layers are not allowed to be adjusted during a backpropagation procedure when training on a new subject data and labels. However, keeping convolutional layer trainable allows a neural language model 132 to continue extracting subject relevant features 142 from variable electrode configurations based on patient specific anatomical electrode trajectories as a group training dataset is transferred from one individual to another. A model trained on an individual, may then transfer across other group members executing a similar, with convolutional layer being trainable while a core LSTM layer and phoneme output layer are frozen. Training on a new individual of a group may then be based upon collation of all subjects and thus may be reduced to only 100 epochs as compared to pre-training on an original individual that may require 500 epochs.

Virtual lesions may be input/applied to/in decoder 130 to evaluate decoding without signals from potential lesions in brain 102. In other words, the mal-regions of the brain 102 are defined and usage of neural signals 140 from mal-regions are minimized or filtered out completely. Thus, in contrast to most current research that conducts occlusion analysis at a single electrode level—the decoder 130 may also evaluate network-level lesional effects on the decoding performance. This ability to lesion speech production specific regions and show their effect on the phoneme decoding architecture allows us to confer some neuroscientific validity to the nonlinear dimensional reduction boundaries that the decoder 130 specially programmed algorithms architecture applies to separating neural responses at the phonemic level.

Lesioning regions significantly affect a neural language model 132, such as a speech model, for an individual, whereas a model for a group will remain robust to single-region lesioning. This resilience is pivotal for tapping into the distributed system of the speech production network to allow generalizing the architecture to datasets with missing regions or dysfunctional language hubs, as is common in aphasia. In a speech model for an individual, lesioning out, for example, the subcentral gyrus (SCG), posterior superior temporal gyrus (pSTG), and superior temporal sulcus (STS) profoundly impacts pre-articulatory speech decoding, resulting in significant degradation of decoding accuracy. Conversely, for a model for speech for a group, lesioning these regions does not diminish the performance improvement they offer compared to a speech model for an individual. However, the extent of improvement is constrained by region availability and coverage density across subjects in group training dataset. Greater electrode coverage in, say the SCG region when deriving the group training dataset may markedly enhance inference performance for subjects with predominantly frontotemporal coverage, with lesioning exerting a notable effect. Having limited electrodes implanted in this region does not diminish the performance gain from the model when transferring its learned latent space for mapping onto subjects with frontotemporal coverage. In other embodiments, this concept would apply to all other regions of the brain, both cortical and subcortical,

A group training dataset may be applied by specially programmed algorithms to produce predicted speed output 434. Predicted speech outputs may include sequence phoneme prediction. Encoder 420/decoder 130 arrangement contributes to production of predicted speech output 434 capable of predicting either a predetermined length of phonemes (CVC model) or variable length of phonemes. Variable length may utilize a teacher-forcing style decoder structure trained on phonemes within a closed dictionary. Model optimization may be accomplished through hyperparameter tuning on a validation dataset.

Predicted speech output 434 may be available through interface 452. Without limitation, interface 452 may be a graphic user interface of a computer, pad, or mobile device. Interface 452 may include display 454. Without limitation, display 454 may present predicted speech output 434 in text or as audio 456. Specially programmed algorithms of encoder 420/decoder 130 may provide a technical improvement over current speech decoders with regard to natural speech events with variable length of utterance sequences. Specially programmed algorithms of encoder 420/decoder 130 may apply three methods that enhance flexibility and capability. Firstly, teacher-forcing style can facilitate information transfer on a phoneme-by-phoneme basis. Secondly, target features accommodate tokens 422.

Tokens 422 may be blank, start, and/or end-of-sentence. Tokens 422 may provide additional information about speech pauses and breaks in utterances. A connectionist temporal classification loss function may be implemented that allows for marginalization of various forms of alignment between predicted and articulated phoneme sequences. This approach provides a technical improvement of optimal handling of merging, concatenation, and deletion of extra tokens predicted, over current speech decoding systems.

Encoder 420 generates neural manifold approximator initialized with group training dataset that enables decoding of neural activity signals from the brain into predicted speech output without requiring excessive parameters. In other words, the neural manifold approximator can enable prediction of intended speech for with minimal/missing parameters due to aphasia.

Accordingly, a machine and process are described that produces a flexible model infrastructure that allows for automated subject-specific cross-validation for variable number of trials per individual during pre-training of a model for a group, which allows a training pipeline to not be limited by some minimum number of trials in a single participant. At least because the machine and process can focus on an ID and a position of a phoneme, data requirements are significantly less than currently existing speed decoding models and provides a brain-to-text decoding framework with accuracy and reduced processing and data collection requirements than currently existing speech decoding models. This architecture can be particularly valuable for non-speaking patients, as it does not rely on spoken speech spectrograms for training. Additionally, neural manifold approximator may also be small, flexible and light weight and can be initialized with multiple patient data, enabling efficient decoding without excessive parameters.

The neural manifold approximator may feed back into decoder 130. In some embodiments, the neural manifold approximator may be used to program a prosthesis 440. In certain embodiments, the prosthesis 440 may be implanted in the brain 102 to provide predicted speech output 434 in real time. Predicted speech output 434 in real time may provide individuals suffering from aphasia with continuous real time assistance and relief. Prosthesis 440 may be formed using a flexible neural state shunt in some embodiments.

FIG. 5 illustrates a schematic diagram illustrating components of a computing device that may be used in certain implementations described herein. The computing device 500 can be representative of data processing system 410, prothesis 440, and/or output device 450.

Referring to FIG. 5, computing device 500 can represent a personal computer, a mobile device, a tablet, a laptop computer, a desktop computer, a server, an IoT device, an application specific IC, or a smart television as some examples. Accordingly, more or fewer elements described with respect to computing device 500 may be incorporated to implement a particular computing device.

Referring to FIG. 5, computing device 500 can include at least one processor 510, a memory 520, software 530 that includes operating system 540 and application 550 stored in the memory 520, network interface 560, and user interface 570. Firmware can also run on device 500. Processor 510 processes data and performs operations according to instructions of software 530. The instructions of application 550 may be loaded into computing device 500 and run on or in association with the operating system 540. Application 550 can include instructions for various operations of the methods described with respect to FIGS. 3A-3C and 4. Memory 520 may comprise any computer readable storage media readable by processor 510 and capable of storing software 530 including application 550. Memory 520 (and any computer-readable storage media forming memory 520) does not consist of propagating signals nor is memory 520 to be considered transitory media. A computer readable medium (or storage medium) can include instructions stored thereon. The instructions when executed by the computing system or computing device 500 direct the computer system to perform the methods detailed herein.

Computing device 500 can further include a user interface 570, which may include input/output (I/O) devices and components that enable communication between a user and the computing device 500 such as, but not limited to, a display, keyboard, mouse, microphone, and speakers. Computing device 500 may also include a network interface 560 that allows the system to communicate with other computing devices, including server computing devices and other client devices, over a network. Network interface 560 can include wired and/or wireless interfaces of one or more communication protocols and/or ports (e.g., for WIFI or Ethernet, BLUETOOTH, near field communication (NFC), etc.)

### Case Study

In a case study consistent with the previous descriptions, a BCI used sparse data from residual intact brain regions, combined with a transfer model from a population of normal individuals to enable the development of a generalizable prosthesis for individuals missing critical functional regions. Stereo-electroencephalography (sEEG) was used to decode activity from distributed speech hubs during the production of tongue twisters specifically designed to stress the articulatory system.

These recordings and a sequence-to-sequence model were used to decode phonemes not only during but also prior to articulation, using latent kinematics of place and manner of articulation from distributed brain regions. A group transfer learning technique was developed and used to train population level neural manifolds implemented as generalizable decoders on patients outside the training population. Improved inference resulted, specifically in patients who had limited coverage of the sensorimotor cortex. The development of generalizable manifolds of speech production coupled with this transfer learning concept facilitates neural prosthetics for aphasia in patients with lesions and insufficient fluency of word production to initialize models.

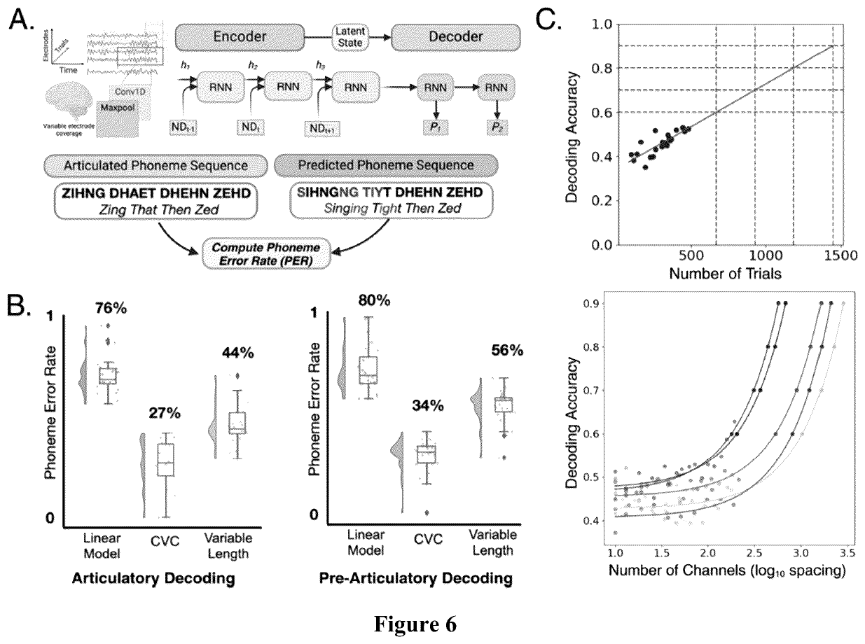

FIG. 6 is a schematic representation of a sequence-to-sequence model utilized in the case study. Section A of FIG. 6 shows processing of neural data with variable cortical coverage by a temporal convolutional layer, a recurrent neural network, and a linear decoder to isolate phoneme identity probabilities for each index in the phoneme sequence. These predicted phoneme sequences (example predicted trial is depicted) are compared using a distance metric to evaluate a phoneme error rate (PER).

Section B of FIG. 6 shows computed PERs for a fixed and variable length Seq2Seq model used for decoding of phoneme sequences during articulation and prior to articulation. Percentages shown are based on a comparison to a multi-output linear model.

Section C of FIG. 6 provides graphs for decoding accuracy plotted against a number of trials and a number of channels. The graphs are for a cohort level trial and related channel statistics from controlled analyses driving decoding performance and extrapolated values for optimal number of trials and channels for high decoding accuracy (1-PER).

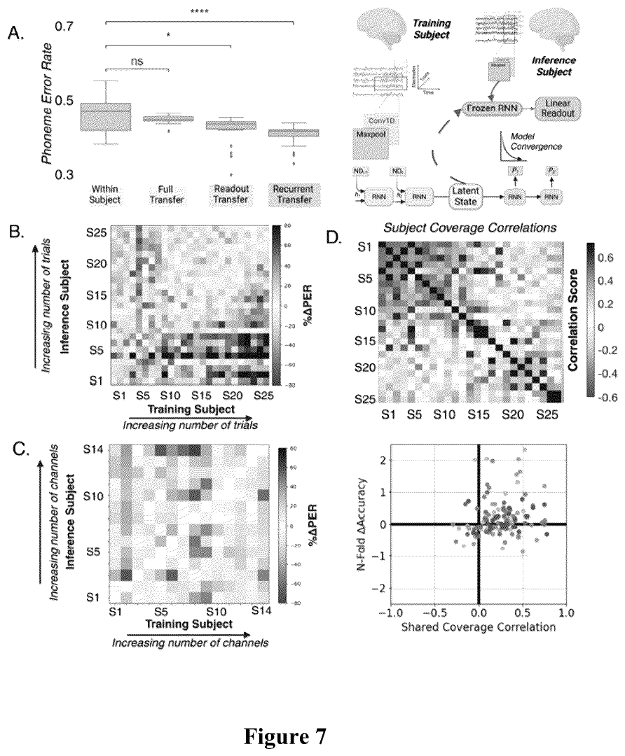

FIG. 7 shows charts related to applying transfer learning to neural models in the case study. Transferability of model components was assessed through PERs, specifically comparing subject-independent models (see Section A). All layers of a trained model were transferred, while freezing weights in the inference model, transferring, freezing the readout layer, and then the recurrent layer. Transfer decoding can allow for improvements in decoding (APER) with training subjects with increased number of trials (see Section B), increased number of channels (see Section C) and shared coverage correlation (see Section D) with the inference subject.

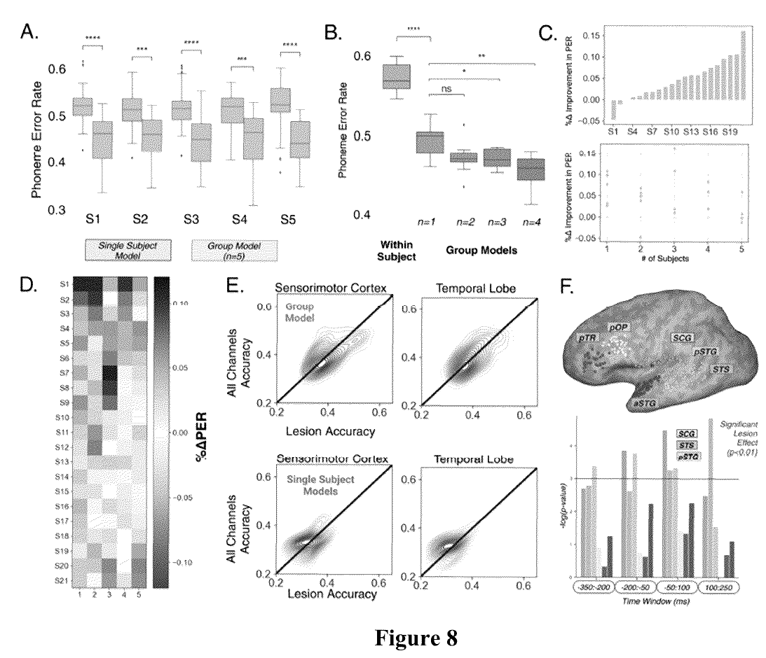

FIG. 8 presents a series of charts related to results of adapting a custom neural language model from a generalized neural language model. Section A of FIG. 8 shows a comparison of a model trained on a subject's own data versus a group-based model, which demonstrated significant improvement in decoding performance for subjects that had comprehensive coverage of the language network with PER on held-out trials (zero-shot decoding) was significantly lower for each subject in the group model when utilizing a shared recurrent layer versus their own data. This finding underscores the value of different neural perspectives of the same behavioral task in enhancing translational decoding capabilities.

Section B shows that applying the population-level manifold learned from the group model to the held-out subject leads to a remarkable enhancement in performance.

Section C and D show that for most subjects (Section C) decoding is comparable or improved when utilizing a transfer learning architecture. An optimal number of subjects trained with a group model will depend on the inference subject preference for subjects in the group model.

Section E shows region specific lesion analysis (for the sensorimotor context and the temporal lobe), which employs linear mixed effects model with random effects for patients across different time windows preceding articulation.

Section F shows virtual focal lesion models created for both the group based (n=5) and single subject decoding architectures.

The case study showcases the effectiveness of large-cohort intracranial sEEG and other related data from other types of penetrating or surface arrays from a cohort in training lightweight, subject-independent models with high decoding accuracy for predicting articulated utterances before speech production. The ability to learn a shared phonemic representation across the cortical surface was demonstrated using pre-trained group models, enhancing performance even for subjects with limited coverage. Superior performance of the multi-subject model suggests that leveraging data from multiple individuals can help overcome subject-specific variations and improve model generalizability. Robust phoneme decoding systems can be created that can accurately translate neural activity into speech outputs across different users.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A computer-implemented method of interpreting speech, language or cognitive intention from brain activity, comprising:
collecting, by a computing system, neural signals from an array of electrodes implanted in or on a brain;
extracting, by the computing system, features from the neural signals to detect distributed signatures of linguistic encoding using non-contiguous coverage the array; and
decoding, by the computing system, linguistic units, including phonemes and semantic embeddings from the extracted features.

2. The computer-implemented method of claim 1, wherein the array is a penetrating array.

3. The computer-implemented method of claim 1, wherein a language region of the brain is not intact, wherein a human having the brain is aphasic due at least in part to the language region of the brain not being intact.

4. The computer-implemented method of claim 1, wherein the decoding utilizes a custom neural language model adapted from a generalizable neural language model, wherein the custom neural language model is fine tuned for a particular individual with the brain.

5. The computer-implemented method of claim 4, further comprising:
training, at the computing system, the generalizable neural language model on recorded data of language regions of brains from a group of subjects with intact speech, language or cognitive intention and function, wherein the custom neural language model is developed for the brain from which the neural signals from the array of electrodes are collected.

6. The computer-implemented method of claim 5, further comprising:
mapping, at the computing system, a portion of the brain from which the neural signals from the array of electrodes are collected to delineate neural code of region that is not intact in another person; and
limiting, by the computing system, the collected neural signals from which the linguistic units are produced to signals from intact portions of the brain.

7. The computer-implemented method of claim 5, wherein the custom neural language model is adapted from the generalizable neural language model using transfer learning techniques.

8. The computer-implemented method of claim 7, wherein the adapting of the custom neural language model from the generalizable neural language model comprises creating a mapping between a shared latent representation space and the brain from which the neural signals from the array of electrodes are collected.

9. The computer-implemented method of claim 5, wherein the group of subjects with the intact speech, language or cognitive intention and function coverage of language regions of their brains have sEEG electrodes or surface subdural grid electrodes implanted as a result of undergoing implantation for some other neural disorder or neural augmentation procedure.

10. The computer-implemented method of claim 9, further comprising:
filtering, at the computing system, raw neural signals from the group of subjects to generate training neural signals used to train the generalizable neural language model, wherein the filtering excludes neural signals with abnormalities due to individual derangements.

11. The computer-implemented method of claim 1, wherein the array is an array of depth electrodes.

12. The computer-implemented method of claim 1, wherein regions of the brain from which the neural signals are collected comprise cortical and subcortical regions.

13. The computer-implemented method of claim 1, wherein regions of the brain from which neural signals are collected comprise at least two of a precentral gyrus, a ventral sensorimotor cortex, a lateral temporal cortex, a ventral temporal cortex, an inferior parietal cortex, an inferior frontal gyrus (IFG), a middle frontal gyrus (MFG), a subcentral gyrus (SCG), a superior temporal gyrus (STG), a middle temporal gyrus (MTG), a lateral premotor cortex, a medial premotor cortex including a supplementary motor area, an inferior parietal cortex, an inferior frontal sulcus, a superior frontal sulcus, a superior temporal sulcus, an inferior temporal gyrus, and an occipitotemporal sulcus.

14. The computer-implemented method of claim 1, wherein the collecting of neural signals occurs during a language task.

15. A system for interpreting speech, language, or cognitive intention from brain activity, the system comprising:
a processor; and
memory storing instructions thereon that when executed by the processor direct the processor to perform a method comprising:
training a generalized neural language model on data from a group of subjects with coverage of intact language regions of their brains;
adapting the generalized neural language model into a custom neural language model for a particular brain, where a language region of the particular brain is not intact; and
decoding linguistic units, including phonemes and semantic embeddings from limited or impaired neural recordings of a human having an aphasic or neurologically disordered brain with a non-intact language region using the custom neural language model.

16. The system of claim 15, wherein each subject of the group of subjects has an implanted penetrating array from which neural signatures are collected.

17. The system of claim 15, wherein at least a portion of the group of subjects have sEEG electrodes or surface subdural grid electrodes implanted as a result of having epilepsy or undergoing implantation for some other neural disorder or neural augmentation procedure, said method further comprising:
filtering raw neural signals from the group of subjects to generate training neural signals used to train the generalized neural language model, wherein the filtering excludes neural signals with abnormalities due to individual derangements.

18. The system of claim 15, wherein adapting the generalized neural language model into a custom neural language model further comprises:
one or more of fine-tuning, weight freezing, and projection transforming the generalized neural language model to create the custom neural language model.

19. The system of claim 15, wherein the generalized neural language model is a parameterized model with standardized 3D brain space to apply surface-based node and cortical spread features in a latent space built from compressing neural data or neural data labeled with linguistic units.

20. The system of claim 15, wherein the generalized neural language model correlates features to regions of the particular brain generating neural signals from which the features were extracted, wherein the custom neural language model primarily utilizes features of the generalized neural language model related to regions of the particular brain outside the region that is not intact.
